(19) United States
(12) Patent Application Publication
(10) Pub. No.: US 2026/0224927 A1
(43) Pub. Date: Aug. 6, 2026

(54) Advanced Fire Blanket

(71) Applicant: Michael Fishman, Parkland, FL (US)

(72) Inventor: Michael Fishman, Parkland, FL (US)

(21) Appl. No.: 19/044,076

(22) Filed: Feb. 3, 2025

(51) Int. Cl. A62C 8/06

(52) U.S. Cl. CPC A62C 8/06

(57) ABSTRACT

A fire blanket made from woven fiberglass fabric with nine-micron continuous filaments enhances fire suppression and durability. The fabric, produced using a plain weave on a shuttleless rapier loom, has a warp density of 17 ends/cm and a weft density of 12 picks/cm, undergoing heat stabilization at 400-450° C. Double-stitched fire-resistant edges prevent fraying, and fireproof hand-pull belts allow rapid deployment. Heat-resistant weights made from ceramic, stainless steel, tungsten, brass, or composites may be sewn into reinforced pockets or integrated as rolled weighted edges secured by high-temperature stitching, heat-sealing, or adhesive reinforcement. Available in multiple sizes, the fire blanket offers stability, ease of handling, and fire resistance for residential, commercial, and industrial applications.

One of the primary concerns with conventional fiberglass fire blankets is the shedding of fiberglass filaments, which can cause irritation to the skin and respiratory system of users. Additionally, many fire blankets lack a secure method for rapid deployment, making them difficult to use effectively in emergency situations. Some traditional blankets do not drape well over fire sources due to their lightweight nature, making them prone to displacement by airflow, forced ventilation, or movement of the fire itself.

Another drawback of existing fire blankets is the lack of stability when covering a fire source. Many traditional designs do not include weighted elements or structural reinforcements, which can make them difficult to position properly. Without sufficient weight, a fire blanket may not remain securely in place, reducing its effectiveness in extinguishing a fire.

This invention addresses these challenges by introducing an improved fire blanket that is woven from continuous nine-micron fiberglass filaments, providing a softer, more flexible material while reducing fiber shedding. The invention also incorporates hand-pull belts that allow for faster and easier deployment, ensuring the blanket can be quickly positioned over a fire source.

Additionally, this invention includes two weighted embodiments to enhance usability. The first embodiment integrates heat-resistant weights into corner pockets or along the perimeter, ensuring that the blanket remains securely in place even in high-airflow environments. The second embodiment features rolled weighted edges, where the edges of the blanket are rolled inward and secured, forming a built-in weighted perimeter without the need for separate added components.

By incorporating these features, this fire blanket provides improved handling, enhanced deployment efficiency, and superior stability compared to conventional fire blankets. These improvements make the invention suitable for use in kitchens, industrial workspaces, laboratories, automotive fire safety, electrical fire protection, and emergency response situations, significantly increasing its effectiveness and reliability in fire suppression applications.

### SUMMARY OF THE INVENTION

The present invention relates to an advanced fire suppression blanket designed for enhanced fire resistance, durability, and ease of deployment. The fire blanket is constructed from a woven fabric composed of continuous fiberglass filaments with a diameter of approximately nine microns. The fabric features a plain weave structure produced on a shuttleless rapier loom, ensuring a uniform and tightly woven material with a warp density of approximately 17 ends per centimeter and a weft density of approximately 12 picks per centimeter. To enhance dimensional stability, durability, and heat resistance, the fabric undergoes an in-line heat stabilization process at temperatures ranging from 400° C. to 450° C.

To reduce fiber shedding and prevent fraying, the edges of the fire blanket are reinforced with double stitching using fire-resistant thread. The blanket includes at least two fireproof hand-pull belts, facilitating rapid deployment and effective placement over a fire source.

The invention further includes multiple embodiments designed to enhance fire suppression efficiency. In one embodiment, the blanket incorporates integrated heat-resistant weights composed of ceramic, stainless steel, tungsten, brass, or composite materials. These weights are strategically positioned within reinforced stitched pockets at the four corners or evenly distributed along the perimeter to enhance stability and ensure optimal coverage, particularly in environments with airflow or forced ventilation.

In another embodiment, the blanket features a rolled weighted edge, wherein the fabric edges are extended, rolled inward, and secured using high-temperature stitching, heat sealing, or adhesive reinforcement. This configuration creates a weighted perimeter without requiring separate weight components, improving draping ability and ease of handling.

The fire blanket is available in various sizes, including but not limited to 1 m×1 m, 1.2 m×1.2 m, and 2 m×2 m, with proportionally adjusted hand-pull belts for different applications. This invention provides improved stability, usability, and fire resistance compared to conventional fire blankets, making it suitable for residential, commercial, and industrial applications, including use in kitchens, laboratories, electrical fire safety, automotive protection, and emergency response situations.

### BRIEF DESCRIPTION OF THE DRAWINGS

The accompanying drawings illustrate various embodiments of the fire suppression blanket and its components.

FIG. 90 illustrates an embodiment of the invention showing the nine-micron fire blanket (180). The two straps (160) and the double-stitched edge (165) are present on all four outer sides of the fire blanket (180), although only one side is labeled for clarity.

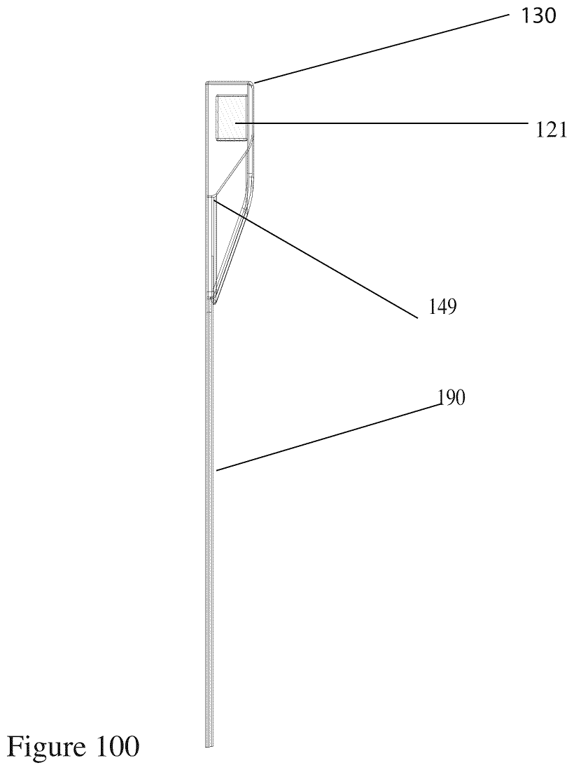

FIG. 100 illustrates one embodiment of the invention in a cross-sectional view, showing the weight (121) at one end of the four-weighted-corner fire blanket (190). The weight (121) is stitched (149) inside the pocket (130) at the end of the weighted fire blanket (190).

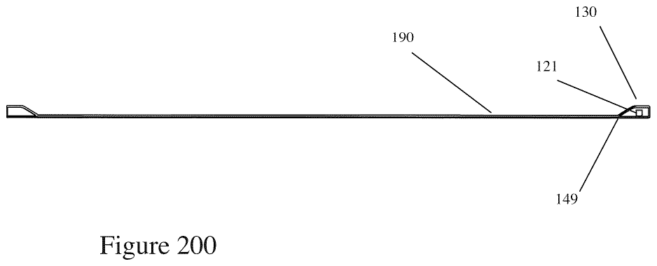

FIG. 200 illustrates a side view perspective of one embodiment of the four-weighted-corner fire blanket (190), showing two corners with the pocket (130) holding the weight (121) inside.

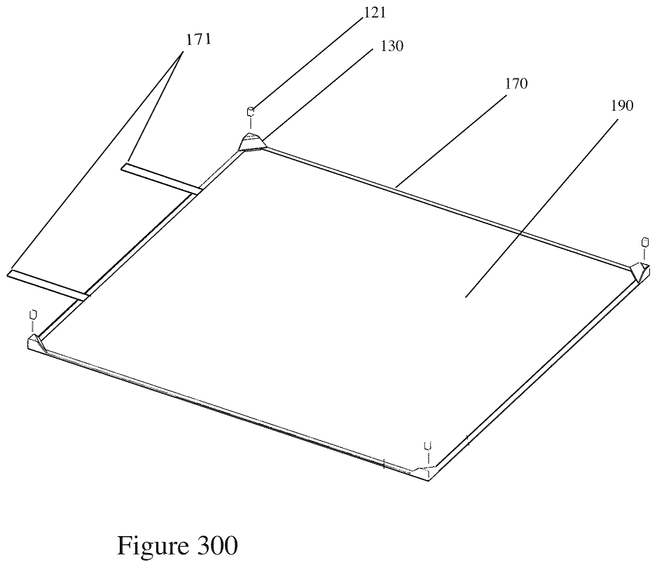

Only one pocket (130) with the weight (121) inside is labeled in the side view for clarity.

FIG. 300 illustrates one embodiment of the four-weighted-corner fire blanket (190) from a top perspective view. The pocket (130) for holding the weight (121) inside is shown. Only one pocket (130) with the weight (121) is labeled out of the four for clarity. Two straps (171) are shown for deployment. The double-stitched side (170) is also shown, with only one of the four outside double-stitched sides (170) labeled for clarity.

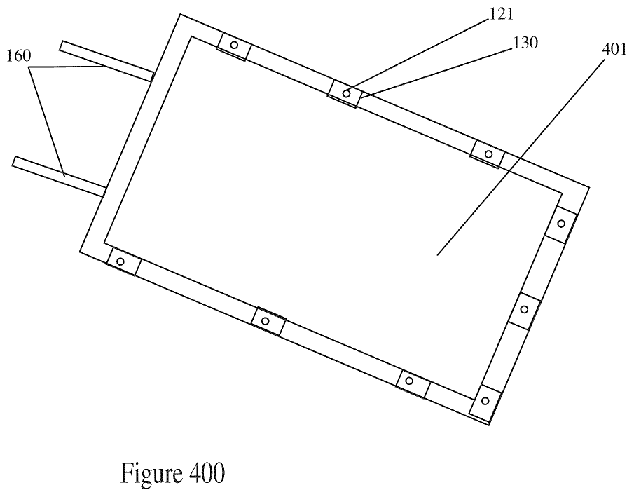

FIG. 400 illustrates another embodiment of the weighted fire blanket invention with weights distributed along the sides of the blanket. The distributed weighted blanket (401) has a pocket (130) with the weight (121) inside. Only one pocket (130) with the weight (121) is labeled for clarity. The distributed weighted blanket (401) also includes two straps (160).

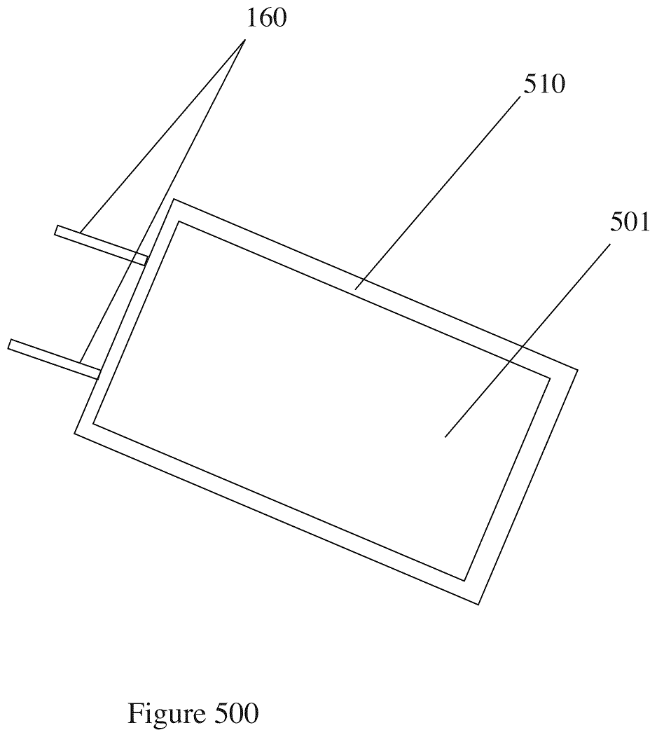

FIG. 500 illustrates a top perspective view of the rolled weighted edge fire blanket (501). The rolled edge (510) is shown extending around all four sides of the blanket, with only one side labeled for clarity. The straps (160) are also shown in this embodiment.

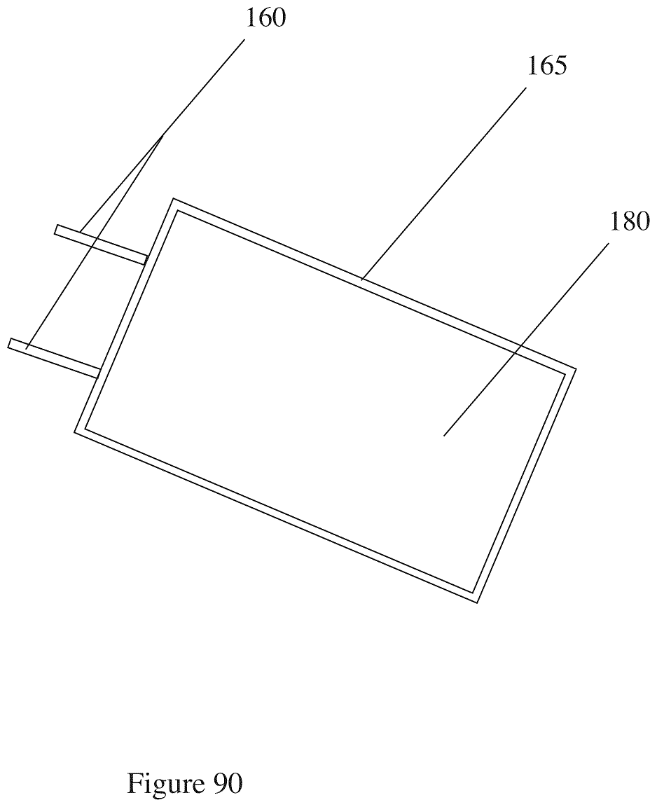

This invention relates to a fire blanket made from continuous fiberglass filaments with a diameter of nine microns (9). The fabric is produced using shuttleless rapier looms, woven in a plain weave structure to create a soft, flexible, and tightly woven material. The fire blanket improves upon traditional fiberglass blankets by preventing fiberglass shards from detaching and penetrating the user's skin, ensuring a safer and more comfortable handling experience. The invention includes various embodiments, including a version with heat-resistant weights placed either along the edges or sewn into the four corners to improve deployment and functionality, and a version with rolled weighted edges.

The fabric used in one embodiment of this fire blanket is woven on a high-precision rapier loom, specifically calibrated to process delicate fiberglass filaments without excessive mechanical stress. The warp density is set at seventeen (17) ends per centimeter, while the weft density is twelve (12) picks per centimeter, ensuring a tight and uniform weave necessary for optimal flame resistance and low porosity. The warp yarns are drawn from bobbins and aligned under a pre-tensioning system, which maintains constant tension at approximately 2.5 to 3.0 Newtons per tex (2.5-3.0 N/tex), preventing excessive stretching or breakage during the weaving process.

The loom operates at a weaving speed of approximately 200 to 250 picks per minute (200-250 ppm), which is carefully regulated to ensure uniformity while avoiding fiber distortion. The warp beams are loaded with fiberglass yarn that has been pre-treated with a high-temperature-resistant sizing agent to improve handling characteristics, reduce brittleness, and enhance fiber cohesion during weaving. The loom's beat-up force is set within the range of 800 to 1200 grams-force per centimeter (800-1200 gf/cm) of fabric width, ensuring firm but controlled compaction of the woven structure without causing fiber breakage or excessive stiffness.

During the weaving process, the rapier insertion system carries the weft yarns across the warp sheet using an electronically controlled gripping mechanism that ensures precise weft placement without generating unnecessary lateral tension. The system is synchronized with the loom's electronic dobby or jacquard control unit, which monitors the weaving cycle to maintain the required tension and alignment across the fabric width. Alternative shuttleless loom configurations, such as air-jet looms, may be used if they achieve the same warp and weft density. Adjustments in weaving speed, tension, and beat-up force may be necessary depending on the loom type used.

To further enhance fabric stability, the woven material undergoes an in-line heat stabilization process immediately after leaving the loom. This process exposes the fabric to a controlled heat treatment at 400 to 450 degrees Celsius (400-450° C.) for three to five (3-5) minutes, allowing the fibers to relax and remove any residual tension caused during weaving. This step also helps to minimize shrinkage and ensures that the fabric remains dimensionally stable when exposed to high temperatures during use.

After the stabilization process, the fabric is inspected using automated defect detection scanners, which identify irregularities such as inconsistent weave density, broken filaments, or loose picks. Sections of fabric that do not meet quality standards are removed, ensuring that only defect-free material is used in the final fire blanket. Once inspected, the material is cut to the required dimensions to allow for final processing and edge finishing. The edges are heat-sealed using a high-temperature laser cutting system, which melts and bonds the filaments together, preventing fraying and fiber shedding. Alternatively, the edges may be serged with high-temperature-resistant thread, reinforced with a high-temperature adhesive, or finished using heat-sealed bias tape or double-stitched reinforcement to ensure durability.

### Enablement for Other Fiberglass Fire Blankets

While one embodiment of the fire blanket utilizes a woven fabric made from continuous nine-micron (9) fiberglass filaments, the weighted and rolled-edge configurations described herein may be applied to fire blankets made from fiberglass filaments of varying diameters and densities, provided that the material maintains structural integrity and fire resistance. The weighted configurations improve handling and deployment across a range of fiberglass fire blankets.

### Weighted Fire Blanket Embodiment

In one embodiment, the fire blanket includes heat-resistant weights, which are integrated into the blanket to improve deployment and fire suppression effectiveness. The weights may be made of ceramic, stainless steel, tungsten, brass, or heat-resistant composite materials. The weights are available in two configurations: one where the weights are evenly distributed along the edges and another where the weights are sewn into the four (4) corners of the blanket. In another embodiment of the invention the weights can be inserted and hook and loop fasteners are used to keep them in the corners. These weights ensure that the blanket remains securely positioned over a fire source, even in conditions where movement or external airflow could displace it.

### Rolled Weighted Edge Fire Blanket Embodiment

In another embodiment, the fire blanket includes rolled weighted edges. In this version, the fire blanket is manufactured with extended edge sections that are rolled inward and secured, forming a weighted perimeter without the need for separate weight components. The rolled edges (510) may be secured using high-temperature stitching, heat-sealing, or adhesive reinforcement, ensuring the structure remains intact during use. The fire blanket is available in multiple sizes, with proportionally adjusted hand-pull belts to accommodate different dimensions. It may be stored in a protective fire-resistant pouch or a mountable storage case for accessibility.

1. A fire blanket comprising a woven fabric constructed from continuous fiberglass filaments having a diameter between 8.5 microns and 9.5 microns, wherein the fabric is woven in a plain weave structure with a warp density between 16 and 18 ends per centimeter and a weft density between 11 and 13 picks per centimeter, wherein the fabric is produced using a shuttleless rapier loom and undergoes an in-line heat stabilization process at a temperature between 400 and 450 degrees Celsius for a duration of at least three minutes, wherein the edges of the fire blanket are double-stitched using fire-resistant thread, wherein the fire blanket includes at least two hand-pull belts made from a fire-resistant material selected from aramid fibers, silicone-treated fiberglass, or carbon fiber, wherein the hand-pull belts are affixed to one side of the fire blanket at spaced intervals for secure gripping and rapid deployment, and wherein the fire blanket is capable of withstanding direct flame exposure for a minimum of ten seconds without combustion or structural failure.

2. A fire blanket comprising a woven fabric made from continuous fiberglass filaments, wherein the fire blanket incorporates heat-resistant weights securely integrated at predetermined locations, wherein the weights are composed of a thermally stable material selected from ceramic, stainless steel, tungsten, brass, or heat-resistant composite materials, wherein the weights are positioned either within reinforced stitched pockets in the four corners of the fire blanket or distributed along the perimeter edges of the fire blanket to enhance deployment efficiency and fire suppression effectiveness, and wherein the weights prevent displacement of the fire blanket due to airflow, movement, or external environmental conditions.

3. A fire blanket comprising a woven fabric made from continuous fiberglass filaments, wherein the fire blanket includes rolled edges that form an integrated weighted perimeter, wherein the perimeter of the fabric is extended and rolled inward to create a continuous weighted edge without requiring separately attached weights, wherein the rolled edges are secured using high-temperature stitching, heat-sealing, or adhesive reinforcement to maintain structural integrity and fire-resistant properties, and wherein the rolled edges may be reinforced with internal metal strips or fire-resistant aramid fibers to enhance durability and stability during deployment.

4. The fire blanket of claim 1, wherein the woven fiberglass fabric has a thickness between 0.43 millimeters and 0.45 millimeters.

5. The fire blanket of claim 1, wherein the warp and weft density are adjustable within a range of 15 to 20 ends per centimeter and 10 to 14 picks per centimeter, respectively.

6. The fire blanket of claim 1, wherein the edges of the fire blanket are further reinforced with a fire-resistant bias tape or a multi-layer folded seam to enhance durability and prevent fraying.

7. The fire blanket of claim 1, wherein the hand-pull belts are affixed using at least two securing methods selected from stitching, heat welding, high-temperature adhesive bonding, and cross-stitching.

8. The fire blanket of claim 1, wherein the fire blanket remains structurally intact after repeated exposure to direct flames for at least ten seconds without combustion, melting, or fiber degradation.

9. The fire blanket of claim 2, wherein each weight is encapsulated within a fire-resistant stitched enclosure to prevent movement or dislodgment during handling and deployment.

10. The fire blanket of claim 2, wherein the weights positioned in the four corners each weigh approximately 50 grams and are symmetrically aligned to optimize weight balance and blanket stability.

11. The fire blanket of claim 2, wherein the weights distributed along the perimeter edges are spaced at regular intervals of at least 10 centimeters for uniform coverage and improved deployment performance.

12. The fire blanket of claim 2, wherein the total weight of the integrated weights constitutes between five percent and fifteen percent of the total weight of the fire blanket.

13. The fire blanket of claim 2, wherein the weighted fire blanket remains flexible enough to be folded or rolled without compromising its structural integrity or fire-resistant properties.

14. The fire blanket of claim 3, wherein the rolled edges are secured using high-temperature-resistant stitching thread capable of withstanding at least 300 degrees Celsius.

15. The fire blanket of claim 3, wherein the rolled edges provide an integrated weighted effect equivalent to at least 50 grams per linear meter of the blanket perimeter.

16. The fire blanket of claim 3, wherein the rolled edges are structured to allow rapid deployment, ensuring the blanket unfurls and covers a fire source with minimal effort.

17. The fire blanket of claim 3, wherein the rolled edges improve the draping ability of the blanket by enhancing its resistance against air currents or forced ventilation.

18. The fire blanket of claim 3, wherein the rolled edges are reinforced with a flexible fire-resistant material such as aramid fibers or high-density woven fiberglass to maintain shape and durability under repeated use.

19. The fire blanket of any of claims 1 through 3, wherein the fire blanket is stored in a fire-resistant pouch or a mountable storage case designed for rapid access and deployment.

20. The fire blanket of any of claims 1 through 3, wherein the fire blanket is pre-folded into a compact arrangement to ensure immediate deployment upon activation of the hand-pull belts.
